(19) United States
(12) Patent Application Publication
(10) Pub. No.: US 2011/0234506 A1
(43) Pub. Date: Sep. 29, 2011

(54) FPCB CONNECTION STRUCTURE OF TOUCH SCREEN PANEL

(75) Inventors: Woon Chun KIM, Gyunggi-do (KR); Jong Young LEE, Gyunggi-do (KR); Yong Soo OH, Gyunggi-do (KR)

(73) Assignee: SAMSUNG ELECTRO-MECHANICS CO., LTD., Gyunggi-do (KR)

(21) Appl. No.: 12/833,615

(22) Filed: Jul. 9, 2010

(30) Foreign Application Priority Data
Mar. 26, 2010 (KR) 10-2010-0027503

(51) Int. Cl. G06F 3/041

(52) U.S. Cl. 345/173

(57) ABSTRACT

Disclosed herein is an FPCB connection structure of a touch screen panel. The FPCB connection structure includes a touch screen panel and an FPCB. The touch screen panel has a connection part in which a plurality of connection holes is formed. The connection holes extend to ends of a plurality of electrode wires. The FPCB includes a substrate having a plurality of lead wires formed thereon, and a plurality of metal pins inserted into the plurality of connection holes to be connected to the ends of the electrode wires via conductive paste. A first through hole passes through the substrate and each of the lead wires, and a second through hole extends from the first through hole and is formed in each of the metal pins in a longitudinal direction thereof.

### CROSS REFERENCE TO RELATED APPLICATION

This application claims the benefit of Korean Patent Application No. 10-2010-0027503, filed on Mar. 26, 2010, entitled “FPCB CONNECTED STRUCTURE OF TOUCH SCREEN PANEL”, which is hereby incorporated by reference in its entirety into this application.

### BACKGROUND OF THE INVENTION

1. Technical Field

The present invention relates to an FPCB connection structure of a touch screen panel.

2. Description of the Related Art

With advances in mobile communication technology, terminals such as mobile phones, PDAs or navigation devices have developed from simple character information display means to various and complex multimedia supply means, such as audio systems, video systems or wireless internet web browsers. Thus, a larger display screen is required in an electronic data terminal of a limited size, so that a display adopting a touch screen panel has attracted considerable attention.

The display adopting the touch screen panel is advantageous in that it combines a screen with a coordinate input means, thus realizing space savings in comparison with the conventional input method using keys. Therefore, in terminals which have been developed recently, a display adopting a touch screen panel has been used so as to increase the size of a screen and make it more convenient to use.

Generally, a resistive touch screen panel has been widely used, because it is simple in structure, thin, and high in productivity. The resistive touch screen panel includes an upper electrode serving as a manipulating side, and a lower electrode serving as a holding side. The electrodes are arranged to be opposite each other and a spacer is used to space them apart from each other by a predetermined gap. Each electrode has electrode wires which are arranged in the X and Y directions.

When a surface of the upper electrode of the resistive touch screen panel is pressed by a user's finger, the upper electrode (an upper substrate having on a surface thereof an electrode film) comes into contact with the lower electrode (a lower substrate having on a surface thereof an electrode film), so that a potential gradient occurs between the electrodes. The voltage is detected and X-axis and Y-axis positions are calculated by a controller, thus determining the point where pressed input occurred.

In order to determine the coordinates of an input point in the above-mentioned manner for the resistive touch screen panel, the electrode wires connected to the electrodes extend to a connection part which is provided at an edge of the touch screen panel. Thus, the electrode wires are connected to an FPCB at the connection part.

In a conventional structure of connecting the electrode wires with the FPCB at the connection part, the FPCB includes metal pins and a substrate. Each metal pin has a shaft part and a head part which has a diameter larger than that of the shaft part. The substrate has lead wires connected to the metal pins.

Further, the connection part of the touch screen panel includes connection holes which extend to the electrode wires.

Here, in order to connect the metal pins to the electrode wires, the metal pins are inserted into the connection holes. Further, in order to improve the reliability of the connection and the coupling force of the metal pins and the electrode wires, the connection holes are filled with conductive paste after which the metal pins are inserted into the connection holes. Thus, an electric current is transmitted between the electrode wires and the metal pins via the conductive paste.

However, the conventional FPCB connection structure has several problems. First, when the connection holes are filled with the conductive paste and thereafter the shaft parts are inserted into the connection holes, the conductive paste may undesirably flow into gaps of the multilayer structure of the touch screen panel. If the conductive paste flowing into the gaps is low in viscosity, neighboring electrode wires may be electrically connected to each other. Meanwhile, if the conductive paste is high in viscosity, an upper substrate made of a thin transparent insulating film, for example, polyethylene terephthalate may bulge out, which leads to a poor appearance.

Further, after the connection holes are filled with the conductive paste, the shaft parts of the metal pins are inserted into the connection holes and a hardening process is performed. Thereby, connecting the connection part and the FPCB has been completed. As the metal pins close the connection holes, air does not circulate smoothly, so that it takes a long time to harden the conductive paste.

### SUMMARY OF THE INVENTION

The present invention has been made in an effort to provide an FPCB connection structure of a touch screen panel using an FPCB which has through holes to contain surplus conductive paste and to circulate air to conductive paste.

In an FPCB connection structure of a touch screen panel according to an embodiment of the present invention, a touch screen panel has a connection part in which a plurality of connection holes is formed. The connection holes extend to ends of a plurality of electrode wires. An FPCB includes a substrate having a plurality of lead wires formed thereon, and a plurality of metal pins inserted into the plurality of connection holes to be connected to the ends of the electrode wires via conductive paste. A first through hole passes through the substrate and each of the lead wires, and a second through hole extends from the first through hole and is formed in each of the metal pins in a longitudinal direction thereof.

The plurality of electrode wires may include an upper electrode wire formed on an upper substrate of the touch screen panel and a lower electrode wire formed on a lower substrate. The plurality of connection holes may include a first connection hole extending to an end of the upper electrode wire and a second connection hole extending to an end of the lower electrode wire. The plurality of metal pins may be inserted into the first and second connection holes, and an upper end of each of the metal pins may be connected to the end of each of the upper and lower electrode wires.

Further, the plurality of electrode wires may include an upper electrode wire formed on an upper substrate of the touch screen panel and a lower electrode wire formed on a lower substrate. The plurality of connection holes may include a first connection hole extending to an end of the upper electrode wire and a second connection hole passing through an end of the lower electrode wire. The plurality of metal pins having identical lengths may be inserted into the first and second connection holes, an upper end of a metal pin inserted into the first connection hole may be connected to the end of the upper electrode wire, and an outer surface of a metal pin inserted into the second connection hole may be connected to the end of the lower electrode wire.

Further, the plurality of electrode wires may be placed on the same plane, and the plurality of connection holes may be formed in the same depth to reach the ends of the electrode wires. The plurality of metal pins having identical lengths may be inserted into the plurality of connection holes such that upper ends of the metal pins are connected to the ends of the plurality of electrode wires.

The first and second through holes may have the same diameter.

Further, the first and second through holes may have an integrated funnel shape.

Further, a diameter of the second through hole may be larger than a diameter of the first through hole.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view illustrating a touch screen panel applied to the present invention;

FIG. 2 is a sectional view illustrating a connection part which may be included in the touch screen panel of FIG. 1;

FIG. 3 is a sectional view illustrating another connection part which may be included in the touch screen panel of FIG. 1;

FIG. 4 is a plan view illustrating an FPCB according to a preferred embodiment of the present invention;

FIG. 5 is a side view illustrating the FPCB of FIG. 4;

FIG. 6 is a sectional view taken along line X-X′ of FIG. 4;

FIGS. 7 and 8 are sectional views illustrating FPCBs according to modifications of FIG. 6; and

FIGS. 9 and 10 are sectional views illustrating FPCB connection structures of touch screen panels, according to preferred embodiments of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention may obscure the gist of the present invention, the detailed description will be omitted.

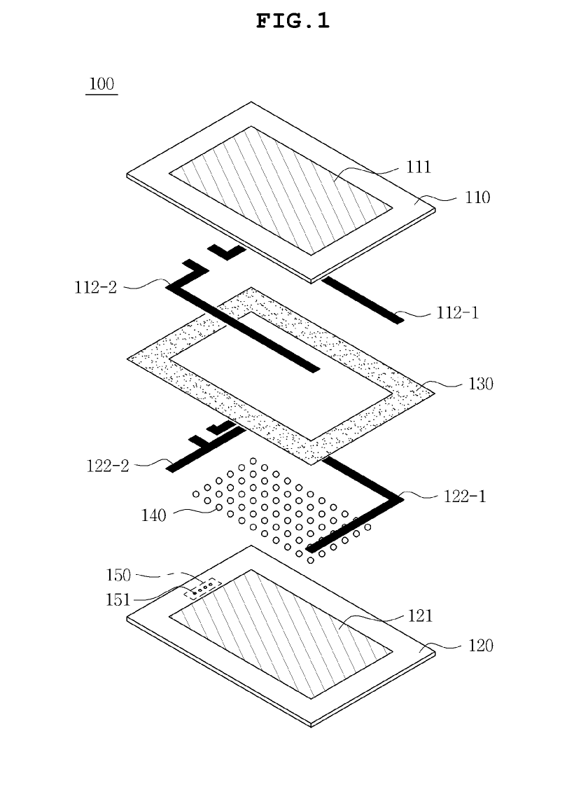

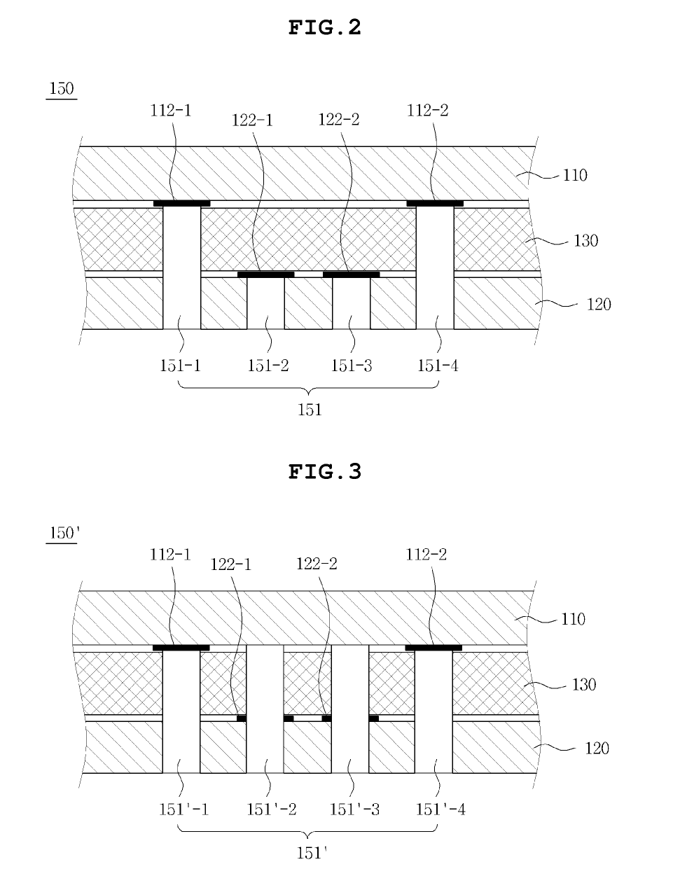

FIG. 1 is an exploded perspective view illustrating an analog resistive touch screen panel which is applicable to the present invention, and FIGS. 2 and 3 are sectional views to illustrating connection parts included in the analog resistive touch screen panel. Hereinafter, the analog resistive touch screen panel will be described with reference to the accompanying drawings.

However, the analog resistive touch screen panel is only one example of the present invention. A digital resistive touch screen panel or a capacitive touch screen panel may be applied to the FPCB connection structure of the present invention.

As shown in FIG. 1, the analog resistive touch screen panel 100 includes an upper substrate 110 and a lower substrate 120 which is installed to be opposite to the upper substrate 110.

An upper transparent electrode film 111, which includes layers of ITO (Indium Tin Oxide), stannic oxide (SnO₂) and indium oxide (In₂O₃) and has a uniform thickness, is patterned on the lower surface of the upper substrate 110 which faces the lower substrate 120. Further, upper electrode wires 112-1 and 112-2 are printed in the X-axis direction to apply an electric current to the upper transparent electrode film 111.

A lower transparent electrode film 121 is patterned on a surface of the lower substrate 120 which faces the upper substrate 110, and lower electrode wires 122-1 and 122-2 are printed in the Y-axis direction to apply an electric current to the lower transparent electrode film 121. Meanwhile, FIG. 1 illustrates a 4-wire touch screen panel among analog resistive touch screen panels, wherein the number of electrode wires may change depending on the type of touch screen panel.

Further, the upper transparent electrode film 111 and the lower transparent electrode film 121 are spaced apart from each other via a spacer 130 which is made of a nonconductor of electricity.

As shown in FIG. 1, the lower transparent electrode film 121 may include dot spacers 140 which are made of insulating synthetic resin such as epoxy or acryl resin so as to prevent improper contact between the electrode films by light pressure.

Here, the upper electrode wires 112-1 and 112-2 and the lower electrode wires 122-1 and 122-2 are arranged such that ends thereof concentrate on edges of the upper substrate 110 and the lower substrate 120. Herein, an area around the edges on which the ends of the upper electrode wires 112-1 and 112-2 and the ends of the lower electrode wires 122-1 and 122-2 concentrate is called a connection part 150.

The connection part 150 includes a plurality of connection holes extending to the ends of the plurality of electrode wires. The construction of the connection part 150 will be described below with reference to FIGS. 2 and 3.

The connection part 150 of FIG. 2 includes four connection holes 151, that is, 151-1 to 151-4. The connection holes 151-1 to 151-4 pass through the lower substrate 120 to extend to the ends of the upper electrode wires 112-1 and 112-2 and the lower electrode wires 122-1 and 122-2.

The connection holes 151-1 to 151-4 of the connection part 150 shown in FIG. 2 are classified into two kinds according to the depth. One of the two kinds is the first connection holes 151-1 and 151-4 which pass through the lower substrate 120 and the spacer 130 and extend to the ends of the upper electrode wires 112-1 and 112-2 formed on the upper substrate 110, while the other kind is the second connection holes 151-2 and 151-3 which pass through only the lower substrate 120 and do not reach the upper substrate 110 but reach the ends of the lower electrode wires 122-1 and 122-2. In the case of forming the two kinds of connection holes, cracks of the touch screen panel which may occur when the connection holes are formed can be minimized

Further, FIG. 3 illustrates a modification of the connection part 150 shown in FIG. 2. In a connection part 150′ according to this modification, all of four connection holes 151′, that is, 151′-1 to 151′-4 pass through the lower substrate 120 and the spacer 130 and extend to the upper substrate 110. Two of the connection holes, that is, the first connection holes 151′-1 and 151′-4 reach the ends of the upper electrode wires 112-1 and 112-2 formed on the upper substrate 110, while two second connection holes 151′-2 and 151′-3 pass through the ends of the lower electrode wires 122-1 and 122-2. As such, if the connection holes 151′-1 to 151′-4 have the same depth, the connection holes 151′-1 to 151′-4 can be simultaneously formed, thus simplifying a manufacturing process.

FIGS. 1 to 3 only illustrates the analog resistive touch screen panel 100 and the connection part 150 thereof. However, based on the diagrams, a digital resistive touch screen panel, a capacitive touch screen panel and a connection part thereof may be expected.

The digital resistive touch screen panel is patterned such that a transparent resistive film is divided into a plurality of parts. For example, the digital resistive touch screen panel may include a plurality of bar-shaped resistive films. Thus, a larger number of electrode wires is required, and a larger number of connection holes is required in the connection part. Further, the capacitive touch screen panel has a connection part which is very similar to that of the digital resistive touch screen panel. However, unlike the digital resistive touch screen panel, a spacer is a transparent insulating layer (in a shape covering a lower electrode pattern).

In a capacitive touch screen panel comprising a single film having X and Y transparent electrode patterns on the same plane, a plurality of electrode wires is placed on the same plane, and a plurality of connection holes has the same depth to reach the ends of the electrode wires. A layering structure through which the connection holes pass is partially different from those of FIGS. 2 and 3.

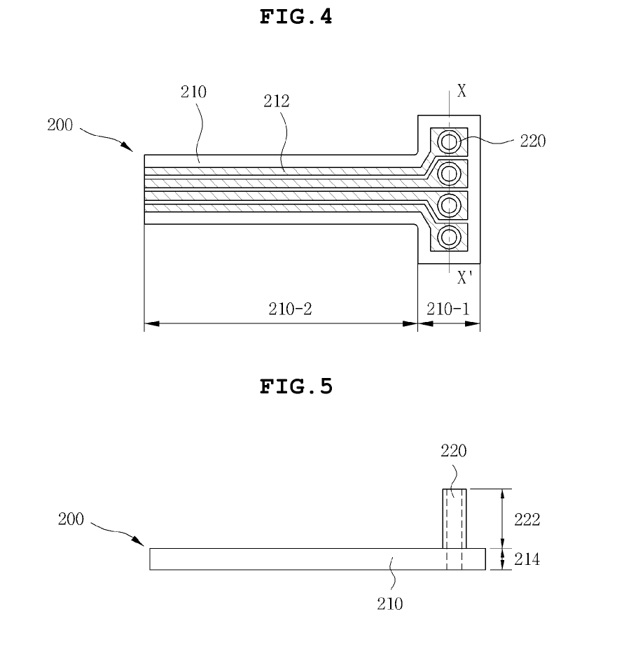

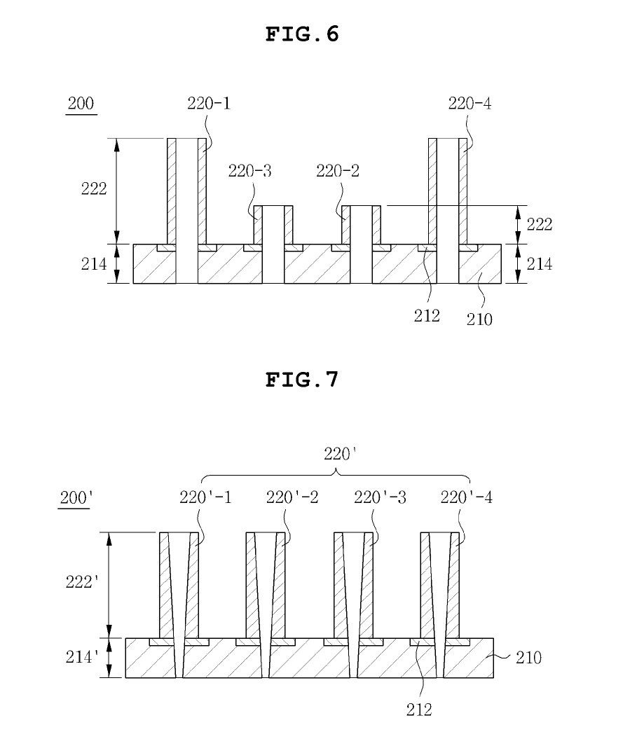

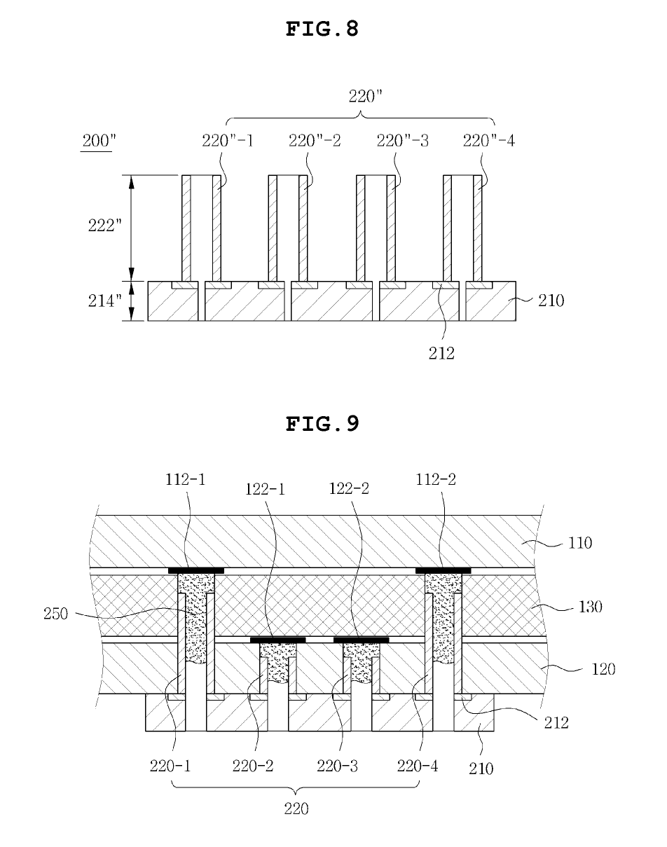

FIG. 4 is a plan view illustrating an FPCB according to a preferred embodiment of the present invention, FIG. 5 is a side view illustrating the FPCB of FIG. 4, FIG. 6 is a sectional view taken along line X-X′ of FIG. 4, and FIGS. 7 and 8 are sectional views illustrating FPCBs according to modifications of FIG. 6. The FPCBs according to the preferred embodiments of the present invention will be described below with reference to the accompanying drawings.

As shown in FIGS. 4 and 5, the FPCB (flexible printed circuit board) 200 according to this embodiment includes a flexible substrate 210 and a plurality of metal pins 220 formed on the substrate 210.

The substrate 210 is made of a heat-resistant plastic film, such as polyester (PET) or polyimide (PI), is divided into a head part 210-1 and a tail part 210-2, and includes a plurality of separate lead wires 212.

The head part 210-1 of the substrate 210 is larger in width (the vertical direction of the drawing) than the tail part 210-2. First through holes 214 are formed in the head part 210-1 and the metal pins 220 are located at the head part 210-1.

The tail part 210-2 of the substrate 210 is longer in length that the head part 210-1, and is connected to a base substrate (a base substrate of a terminal such as a mobile phone, PDA, or navigation device).

Further, the plurality of lead wires 212 is formed in such a way as to extend from the head part 210-1 of the substrate 210 to the tail part 210-2 thereof. The metal pins 220 having the second through holes 222 adhere to head portions of the lead wires 212 to apply an electric current to the metal pins 220. Thus, the head portions of the lead wires 212 preferably have a width which is larger than the diameters of the metal pins 220 to allow the metal pins 220 to adhere to the head portions.

The shape of the first through holes 214 formed in the head part 210-1 of the substrate 210, the metal pins 220 and the second through holes 222 formed in the metal pins 220 will be described with reference to FIGS. 6 to 8.

First, the shape of the metal pins 220 according to the preferred embodiment of the present invention will be described with reference to FIG. 6. The four metal pins 220, that is, 220-1 to 220-4 are connected to the lead wires 212 formed on the substrate 210. Here, the metal pins 220-1 to 220-4 are classified into two kinds according to the length. The reason why the FPCB 200 has two kinds of metal pins having different lengths is because the FPCB 200 is used for the connection with the touch screen panel of FIG. 2. The connection structure will be described later with reference to FIG. 9.

The FPCB 200 including two kinds of metal pins 220 having different lengths may to be applied to the connection structure of the touch screen panel having the connection part shown in FIG. 2.

Meanwhile, the metal pins 220-1 to 220-4 are formed to correspond to the shape of the connection holes which are formed in the connection part of the touch screen panel. Since an electric current is transmitted, via conductive paste, between the metal pins 220-1 to 220-4 and the electrode wires, it is preferable that the metal pins 220-1 to 220-4 be slightly shorter than the depth of the connection holes.

Next, the shapes of the first and second through holes 214 and 222 according to the preferred embodiment of the present invention will be described with reference to FIG. 6. The first through holes 214 are formed in the head part 210-1 of the substrate 210. Here, the first through holes 214 pass through the lead wires 212 formed on the head part 210-1 as well as the head part 210-1 of the substrate 210.

Further, the second through holes 222 extend from the first through holes 214 and are formed in the metal pins 220 in a longitudinal direction thereof. Here, the first through holes 214 and the second through holes 222 have the same diameter.

After the metal pins 220 having no second through hole adhere to the head part 210-1 of the substrate 210 having no first through hole to transmit an electric current between the metal pins 220 and the lead wires 212, through holes may be formed using a drilling bit or a similar tool. In this case, the diameters of the first and second through holes 214 and 222 become equal to each other. Such a method is advantageous in that the through holes can be formed without performing work twice, thus enabling easy manufacture. Meanwhile, the first and second through holes 214 and 222 have the same diameter, and the diameter may be adjusted.

FIGS. 7 and 8 are sectional views illustrating the modifications of the FPCB shown in FIG. 6. FPCBs according to other embodiments of the present invention will be described with reference to FIGS. 7 and 8.

All metal pins included in the FPCBs of FIGS. 7 and 8 have the same length. For to example, the FPCB 200′ or 200″ having the metal pins 220′ or 220″ may be applied to the connection structure of the touch screen panel shown in FIG. 3.

When the metal pins 220′ or 220″ of the FPCB having the same length adhere to the head part 210′-1 or 210″-1 to transmit an electric current between the metal pins 220′ or 220″ and the lead wires 212, a manufacturing process is simplified owing to the same metal pins. The FPCB having the metal pins of the same length may be applied to the connection structure of the single film type touch screen panel.

In the FPCB 200′ of FIG. 7, the second through holes 222′ extend from the first through holes 214′, and each of the second through holes 222′ and each of the first through holes 214′ have the shape of an integrated funnel. Thus, the diameters of the through holes are gradually reduced in a direction from the second through hole 222′ to the first through hole 214′.

The funnel-shaped through holes 214′ and 222′ contain surplus conductive paste therein, and air circulates from the first through holes 214′, thus making it easy to harden the conductive paste. After the metal pins 220′ having no second through hole adhere to the head part 210′-1 of the substrate 210′ having no first through hole such that an electric current is transmitted between the metal pins 220′ and the lead wires 212, the through holes may be simultaneously formed using a drilling bit or a similar tool.

The FPCB 200″ of FIG. 8 is constructed so that second through holes 222″ extend from first through holes 214″, and the diameter of each second through hole 222″ is larger than that of each first through hole 214″.

Thus, surplus conductive paste is contained in the second through holes 222″, and air is circulated from the first through holes 214″ to conductive paste. The FPCB 200″ may be formed by adhering the metal pins 220″, that is, 220″-1 to 220″-4 having the second through holes 222″ to the lead wires 212 in which the first through holes 214″ are formed.

Such an FPCB 200″ is formed such that the diameter of each of the first through holes 214″ passing through the lead wires 212 is very small, thus preventing damage to the lead wires 212, and the second through holes 222″ contain a sufficient amount of surplus conductive paste.

FIG. 9 illustrates a connection structure wherein the FPCB 200 of FIG. 6 is connected to the connection part 150 of the touch screen panel 100 of FIG. 2.

As shown in FIG. 9, two kinds of metal pins 220 having different lengths are inserted into the first connection holes 151-1 and 151-4 and the second connection holes 151-2 and 151-3, which have different depths.

The ends of the electrode wires 112-1, 112-2, 122-1 and 122-2 and the metal pins 220 are connected to each other by the conductive paste 250. Especially, in FIG. 9, the ends of the electrode wires 112-1, 112-2, 122-1 and 122-2 are connected to the upper ends of the plurality of metal pins 220, that is, 220-1 to 220-4 via the conductive paste 250.

When the connection holes 151 of the connection part 150 are filled with the conductive paste 250 and thereafter the metal pins 220 are inserted into the connection holes 151, the first and second through holes 214 and 222 may contain surplus conductive paste, thus preventing the conductive paste from undesirably flowing into gaps of a multilayer structure, and preventing neighboring electrode wires from being electrically connected to each other, in addition to preventing the upper substrate made of a thin transparent insulating film from bulging out.

Moreover, air is introduced through an end of each first through hole 214, thus shortening the hardening time of the conductive paste.

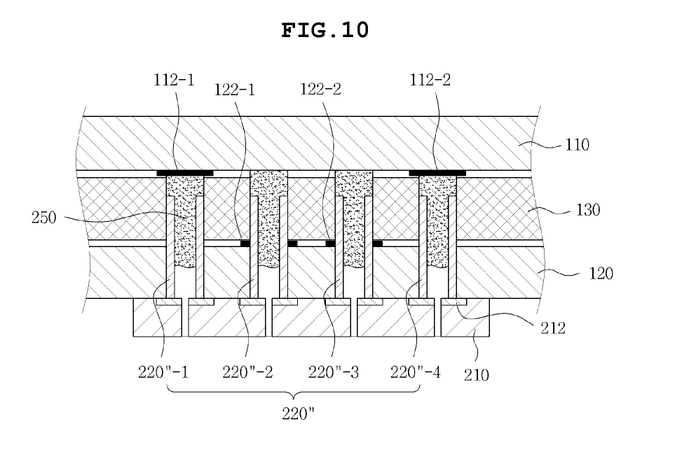

FIG. 10 illustrates a connection structure wherein the FPCB 200″ of FIG. 8 is connected to the connection part 150 of the touch screen panel 100 of FIG. 3. Further, the FPCB 200′ of FIG. 7 may be also applied to the touch screen panel.

The connection structure of FIG. 10 has the same effect as the connection structure of FIG. 9. Here, the lower electrode wires 122-1 and 122-2 are connected to the outer surfaces of the metal pins 220″-2 and 220″-3.

Meanwhile, when the touch screen panel of FIG. 10 is a single film type capacitive to touch screen panel having X and Y transparent electrode patterns on the same plane, a plurality of electrode wires is placed on the same plane. Thus, the upper ends of all the metal pins 220″ are connected to the electrode wires via the conductive paste.

In this case, the layering structure of the touch screen panel through which the connection holes pass is partially different from that of FIG. 10. Since the single film type capacitive touch screen panel is known to those skilled in the art, a detailed description will be omitted herein.

As described above, the present invention provides an FPCB connection structure of a touch screen panel, in which an FPCB includes a metal pin having a through hole formed therein, thus preventing conductive paste from being undesirably introduced into gaps of a multilayer structure of the touch screen panel even though a connection part of the touch screen panel is filled with conductive paste and then is connected to the FPCB. Therefore, electric connection between neighboring electrode wires can be prevented.

Further, the present invention provides an FPCB connection structure of a touch screen panel, which prevents an upper substrate made of a thin transparent insulating film from bulging out, thus providing a good appearance.

Furthermore, the present invention provides an FPCB connection structure of a touch screen panel, which permits the inflow of air through a through hole formed in a substrate while conductive paste is hardened to attach a metal pin to a connection part, thus shortening the hardening time of the conductive paste, therefore increasing productivity and improving workability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An FPCB connection structure of a touch screen panel, comprising:
a touch screen panel having a connection part in which a plurality of connection holes is formed, the connection holes extending to ends of a plurality of electrode wires; and
an FPCB including:
a substrate having a plurality of lead wires formed thereon; and
a plurality of metal pins inserted into the plurality of connection holes to be connected to the ends of the electrode wires via conductive paste, a first through hole passing through the substrate and each of the lead wires, and a second through hole extending from the first through hole and being formed in each of the metal pins in a longitudinal direction thereof.

2. The FPCB connection structure as set forth in claim 1, wherein the plurality of electrode wires comprises an upper electrode wire formed on an upper substrate of the touch screen panel and a lower electrode wire formed on a lower substrate, and the plurality of connection holes comprises a first connection hole extending to an end of the upper electrode wire and a second connection hole extending to an end of the lower electrode wire, and
the plurality of metal pins are inserted into the first and second connection holes, an upper end of each of the metal pins being connected to the end of each of the upper and lower electrode wires.

3. The FPCB connection structure as set forth in claim 1, wherein the plurality of electrode wires comprises an upper electrode wire formed on an upper substrate of the touch screen panel and a lower electrode wire formed on a lower substrate, and the plurality of connection holes comprises a first connection hole extending to an end of the upper electrode wire and a second connection hole passing through an end of the lower electrode wire, and
the plurality of metal pins having identical lengths are inserted into the first and second connection holes, an upper end of a metal pin inserted into the first connection hole being connected to the end of the upper electrode wire, an outer surface of a metal pin inserted into the second connection hole being connected to the end of the lower electrode wire.

4. The FPCB connection structure as set forth in claim 1, wherein the plurality of electrode wires is placed on the same plane, and the plurality of connection holes is formed in the same depth to reach the ends of the electrode wires, and
the plurality of metal pins having identical lengths is inserted into the plurality of connection holes such that upper ends of the metal pins are connected to the ends of the plurality of electrode wires.

5. The FPCB connection structure as set forth in claim 1, wherein the first and second through holes have the same diameter.

6. The FPCB connection structure as set forth in claim 1, wherein the first and second through holes have an integrated funnel shape.

7. The FPCB connection structure as set forth in claim 1, wherein a diameter of the second through hole is larger than a diameter of the first through hole.
